(19) United States
(12) Patent Application Publication
(10) Pub. No.: US 2026/0201921 A1
(43) Pub. Date: Jul. 16, 2026

(54) MOTOR-VEHICLE COMPONENT AND METHOD FOR MANUFACTURING A MOTOR-VEHICLE COMPONENT

(71) Applicant: Benteler Automobiltechnik GmbH, 33102 Paderborn (DE)

(72) Inventors: Peter Michael Stastny, Delbrück (DE); Ralf Ilskens, Paderborn (DE); Carsten Trippe, Salzkotten (DE)

(73) Assignee: Benteler Automobiltechnik GmbH, 33102 Paderborn (DE)

(21) Appl. No.: 19/545,849

(22) Filed: Feb. 20, 2026

Related U.S. Application Data
(63) Continuation of application No. PCT/DE2024/100755, filed on Aug. 23, 2024.

(30) Foreign Application Priority Data
Aug. 24, 2023 (DE) 10 2023 122 700.9

(51) Int. Cl. F16B 43/00

(52) U.S. Cl. CPC F16B 43/00

(57) ABSTRACT

A metallic component body includes a mounting opening and a friction structure which surrounds the mounting opening and includes elevations and/or depressions. The friction structure is embossed and hardened, wherein the embossed and hardened friction structure includes laser dimples. The friction structure includes ribs produced by embossing such as to extend radially outward from the mounting opening.

### CROSS-REFERENCES TO RELATED APPLICATIONS

This application is a continuation of prior filed copending PCT International Application No. PCT/DE2024/100755, filed Aug. 23, 2024, which designated the United States and has been published as International Publication No. WO 2025/040219A1 , on which priority is claimed under 35 U.S.C. § 120, and which claims the priority of German Patent Application, Serial No. 10 2023 122 700.9, filed Aug. 24, 2023, pursuant to 35 U.S.C. 119(a)-(d).

The contents of International Application No. PCT/DE2024/100755 and German Patent Application, Serial No. 10 2023 122 700.9 are incorporated herein by reference in their entireties as if fully set forth herein.

### BACKGROUND OF THE INVENTION

The invention relates to a motor-vehicle component and to a method for producing a motor-vehicle component.

The following discussion of related art is provided to assist the reader in understanding the advantages of the invention, and is not to be construed as an admission that this related art is prior art to this invention.

Motor-vehicle components, such as body components or structural components, are oftentimes connected to other components and/or add-on components or assembled from several components or component parts. The connection of the components and parts is realized, i.a., via screw connections. Screws or bolts are hereby inserted into or through mounting openings and tightened and counter-supported. Depending on the application, washers are incorporated for this purpose. Placed between the screw head and the component body to be fastened with the screw, a washer serves to distribute and transfer the force exerted by the underside of the screw head to a larger area of the component body. In the case of through-bolts, a washer is also provided under the lock nut, depending on the application.

It would be desirable and advantageous to obviate prior art shortcomings and to functionally improve a motor-vehicle component with a metallic component body and an embossed and hardened friction structure.

### SUMMARY OF THE INVENTION

According to one aspect of the present invention, a motor-vehicle component includes a metallic component body including a mounting opening and a friction structure which surrounds the mounting opening and includes elevations and/or depressions, with the friction structure being embossed and hardened, wherein the embossed and hardened friction structure includes laser dimples, and wherein the friction structure includes ribs produced by embossing such as to extend radially outward from the mounting opening.

In accordance with the invention, the mounting opening and the friction structure form a connection point on the motor-vehicle component, via which a screw connection can be made with another motor-vehicle component or a component part. The screw connection is realized via screw elements. Screw elements are, in particular, screws or bolts or nuts. During assembly, a connecting screw is inserted into or through the mounting opening and coupled with another motor-vehicle component or component part. As a result, the components are braced. The mounting opening can be a through hole or a bore with an internal thread. The friction structure is embossed directly into the component body by displacing material so as to provide the friction structure with elevations and/or depressions. To ensure that the embossed friction structure interlocks better with adjacent components, the friction structure is hardened at least in some areas. In accordance with the invention, the embossed and hardened friction structure is additionally provided with laser dimples. Laser dimples may also referred to as pits that are created by a laser beam on the surface structure. This process creates unevenness in the surface, caused by a partial melting of the material using a laser beam. Laser hardening does not yet produce laser dimples because hardening is carried out at temperatures below the melting point of the material. Rather, the laser dimples are only realized when the melting temperature is exceeded. This is the case with the invention. For this purpose, hardening is carried out at a slightly higher temperature so that the material is partially melted and heated in the heat-affected zone around the melting area with the objective of hardening the material. Hardening and creation of the laser dimples are carried out in a single operating step. A micrograph shows the laser dimples and the structural changes caused by hardening in the area of the laser dimples.

The presence of laser dimples on the friction structure improves functional properties of the friction structure in terms of topology and in terms of engagement with the adjacent component that is braced to the motor-vehicle component according to the invention. The friction structure can be produced cost-effectively, as no material needs to be added. There is no need to connect separately manufactured washers to the motor-vehicle component through welding or via a form-fit. In addition, hardening and production of the laser dimples can be carried out in a single operating cycle. As a result, the embossed and hardened friction structure with laser dimples can increase friction at the mounting opening or in the area around the mounting opening and efficiently transfer the force exerted by a screw element to the surface in the area of the friction structure. Screw elements are held more securely and the connection can transmit higher transverse forces with the same contact pressure. As a consequence, smaller screw elements, such as mounting screws, can advantageously be used. The motor-vehicle component saves on material and weight thanks to the integrated friction structure, i.e., the elimination of loose or fixed washers.

The friction structure can be optimally adapted to the connection point of the motor-vehicle component in terms of its spatial design and arrangement.

The friction structure has ribs produced through embossing, which extend radially outward from the mounting opening. Advantageously, the ribs can run in a radial direction, i.e., they have a radial course in relation to a center point of the mounting opening. The ribs are elevations relative to the areas adjacent to the ribs. The ribs provide the necessary friction and are subject to high loads during tightening. Therefore, the ribs of the friction structure should be hardened.

According to another advantageous feature of the invention, the laser dimples can be arranged on the ribs for this purpose. As a result, the ribs do not have a straight, linear course, particularly in the area of their rib crest, but have surface irregularities corresponding to the number and arrangement of the laser dimples.

According to another advantageous feature of the invention, the ribs can have a height which increases radially outward, wherein a rib crest has a mean pitch of 0.025 to 3°, in particular 0.5 to 1.5°. Advantageously, the pitch can be 1°from a radially inner end of the rib comb to a radially outer end of the rib comb. A mean pitch is the arithmetic mean pitch over a plurality of measuring points between the inner end of the rib crest and the outer end of the rib crest.

Regardless of the pitch, according to another advantageous feature of the invention, the ribs can have a mean height measured over their length of 0.05 to 0.9 mm, in particular from 0.1 to 0.4 mm. The mean height is the arithmetic mean height over a plurality of measuring points along the length of the rib in the area of the rib crest. A rib with a mean height of 0.1 mm has a height of less than 0.1 mm on the radial inner side and a height of slightly more than 0.1 mm on the radial outer side at a pitch of 0.5 to 1.5°. Thus, for a rib with a mean height of 0.4 mm, the radially outer end of the rib is slightly higher on the radially outer side at a corresponding pitch of the rib. Precise values depend on the length of the rib and manufacturing tolerances.

The rib crest in particular can be structured by the formation of laser dimples, because the melting point is exceeded first at the rib crest due to reduced heat dissipation into adjacent areas. The laser dimples are arranged at a distance to each other in longitudinal direction of the rib. There may be an area without laser dimples, i.e., a gap, between two successive laser dimples. The laser dimples of adjacent ribs can be arranged offset from each other in the radial direction, e.g., by half a gap. In this way, viewed in the circumferential direction of the mounting opening, laser dimples are advantageously located in each radial area of the ribs, thereby further improving interlocking of the friction structure with a mating component. The laser dimples are not intended to form an additional ring-shaped structure in the form of several concentric rings on the radially arranged ribs. Rather, the laser dimples are advantageously arranged at different radial distances from rib to rib and, advantageously, offset by at least half the width of a laser dimple. The radial offset of the laser dimples from rib to rib may also be significantly smaller and, for example, amount to 1/n, wherein n designates the number of ribs. In this case, all laser dimples are arranged offset from each other in the radial direction.

Advantageously, laser dimples can be created that vary in size and shape. In particular, ribs can be provided with laser dimples to create a staircase structure of the ribs that slopes down toward the mounting opening. The shape and size of the laser dimples can be controlled by the energy input (power, pulse duration) and the focus position of the laser, so that the ribs can be structured to a greater or lesser extent.

Advantageously, the ribs can have a triangular cross-section. The ribs, which taper to the rib crest, have a rounded rib crest after embossing. The ribs can have flanks that can form an angle of 60 to 90° to each other. Heat input into the slender rib crest is particularly high during laser treatment, so that melting is more likely to occur in the area of the rib crest than in the area of the flanks. The design of the laser dimples can be controlled, e.g. by guiding the laser beam (irradiation angle, focus position) and suitable power parameters (exposure time, power), to create a 3D-profiled surface which, due to heat-affected zones that can be adjusted to different sizes, can have a hardness in a range of 250 to 420 HV, at least in some areas, and in particular in a range of 270 to 340 HV. These hardness values are only attained in the hardened areas of the friction structure, i.e. where the laser treatment is performed. In particular, the ribs are among the hardened areas of the friction structure. The friction structure may have unhardened areas, in particular between the ribs.

Advantageously, the mounting opening may be completely or partially surrounded by the friction structure. The friction structure advantageously can border directly on the mounting opening, optionally may be limited by a chamfer on the mounting opening to facilitate mounting. The friction structure is advantageously circular and can have an outer diameter which corresponds to approximately 1.5 to 2 times a diameter of the mounting opening.

A motor-vehicle component according to the invention may involve axles, axle components or axle bodies, for example subframes, as well as assemblies, carriers, for example wheel carriers. A motor-vehicle component according to the invention can be manufactured in steel construction, advantageously from interconnected shell-shaped component bodies which have connection points designed according to the invention with mounting openings and friction structures surrounding them.

According to another aspect of the invention, a method for producing a motor-vehicle component includes producing a mounting opening in a metallic component body, producing a friction structure on a circumference of the mounting opening by an embossing process, hardening the friction structure by a laser beam process, forming laser dimples on raised ribs of the friction structure, and hardening at least one area of the ribs as the laser dimples are formed.

The metallic component body can be made of hardenable steel with the mounting opening. The mounting opening can be partially or completely surrounded by the friction structure. The embossing process may involve a cold pressing process. The thus produced friction structure is hardened by the laser beam process and the laser dimples are formed on the friction element. During hardening of the friction structure by the laser beam process, the material itself is not melted, but only heated. During formation of the laser dimples, the material is partially melted, so that the geometric surface changes in the form of laser dimples. In accordance with the invention, laser hardening and formation of laser dimples are combined. In terms of the process, the advantage here resides in that the heat input of the laser beam process for hardening simultaneously forms the laser dimples on the friction element. Energy consumption and thus manufacturing costs are significantly lowered compared to separately executed processes.

The laser dimples are advantageously formed on raised ribs of the friction structure, with the ribs being hardened at the same time as the laser dimples are produced.

A difference between hardening and producing laser dimples is that during hardening, the power of a laser is significantly reduced, but exposure time is increased. If, on the other hand, the material is to be cut using a laser process, it must be melted. In this case, the intensity, i.e., the power of the laser, is increased. The production of laser dimples is technically between hardening and cutting. It is carried out with a relatively long exposure time of the laser at a comparatively low intensity, so that the surface areas of the friction structure are melted but not vaporized. The material is hardened in the heat-affected zone.

By selecting appropriate parameters, care must therefore be taken not only to heat the material, as is the case with hardening, but also to adjust the intensity and irradiation time so that surface areas are melted in order to effect the formation of laser dimples.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a top view of a motor-vehicle component having thereon a friction structure;

FIG. 2 shows a cross-section through a rib of the friction structure;

FIG. 3 shows a longitudinal section of a rib of the friction structure through the motor-vehicle component;

FIG. 4 shows a diagram illustrating a relationship between the intensity of a laser beam and the irradiation time; and

FIG. 5 shows micrographs of different laser dimples.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

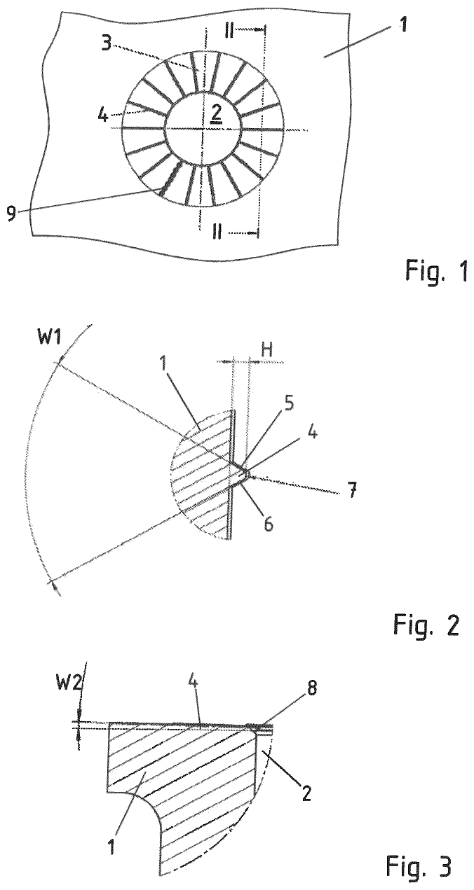

Turning now to the drawing, and in particular to FIG. 1, there is shown a top view of a motor-vehicle component 1 with a mounting opening 2 and a friction structure 3. The friction structure 3 has a plurality of radially arranged, straight ribs 4 which extend from radial inside to radial outside in relation to the mounting opening 2. There are a total of 18 ribs 4 evenly distributed around the circumference. A rib 4 is shown in cross-section in FIG. 2 and has a height of 0.3 mm. The rib 4 has a triangular cross-section and widens towards its base. Its straight flanks 5, 6 are at an angle W1 of 60° to each other and merge into a rib crest 7. The rib crest 7 is rounded. All ribs 4 are identical. They are produced by an embossing process.

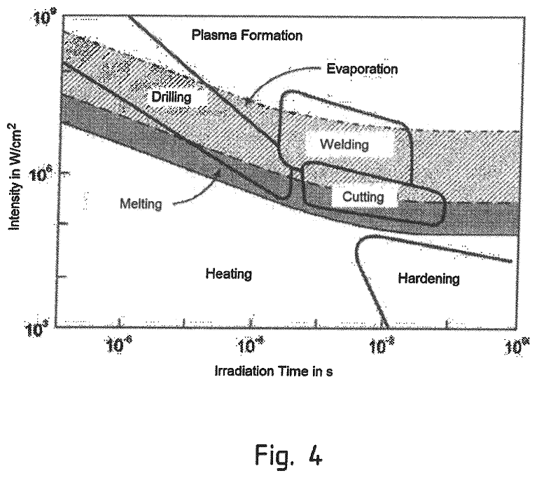

FIG. 3 shows a longitudinal section of a rib 4 having a height which increases linearly radially outward. The pitch angle W2 in this exemplary configuration is 1°+/−0.5°. There is a chamfer 8 at the radially inner mounting opening 2.

Further shown in FIG. 1 and designated with reference numeral 9 is the position of a laser dimple 9 which is produced through laser beam action and shown purely as an example and not to scale. The laser dimple 9 is formed on the rib 4. A multiplicity of such laser dimples 9 are arranged around the circumference of the friction structure 3 and are each located in the area of the ribs 4. Several laser dimples 9 distributed in the radial direction are arranged on each rib 4. The laser dimples 9 of adjacent ribs 4 can be arranged offset from each other in the radial direction. The laser dimples 9 are produced by a same laser treatment used to harden parts of the friction structure 3.

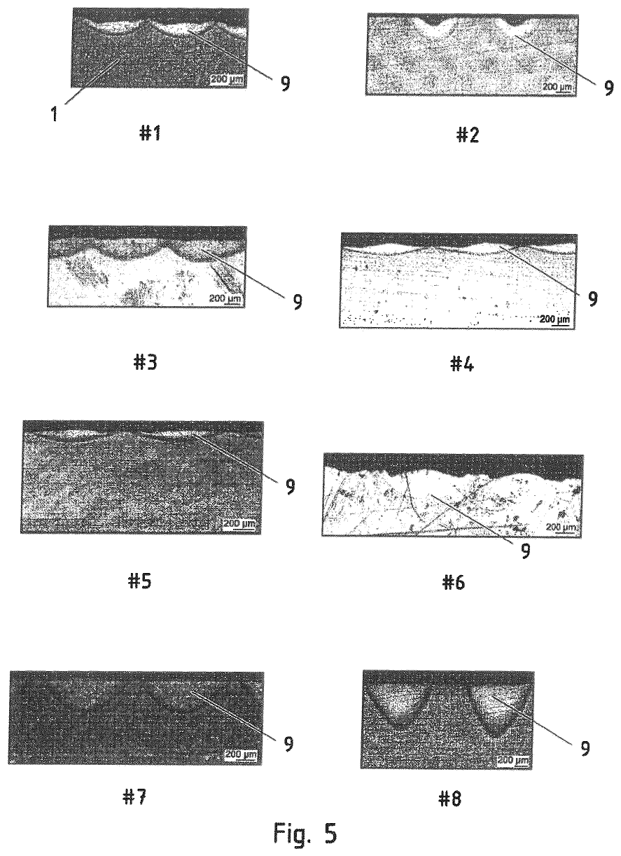

FIG. 4 shows a diagram illustrating a relationship between the intensity of a laser beam, specified in watts per square centimeter, and the irradiation time in seconds. The hardening process takes place at a comparatively low intensity and a longer irradiation time. The material is not melted. When the material is melted, areas of cutting, drilling or, after evaporation, plasma formation are reached. The production of laser dimples 9 is realized in the range between cutting and hardening, i.e., it takes place at a comparatively long irradiation time and low intensity, which only needs to be high enough to melt the surface. Depending on the focus, pulse duration, and power of the laser, the laser dimples 9 can have different structures, as can be seen in the exemplary micrographs shown in FIG. 5.

The micrographs are not necessarily located in the plane of the highest or lowest elevation of the laser dimples 9. Therefore, different grinding depths may occur in different grinding planes. However, the images clearly show that, depending on the size of the heat-affected zone, the laser dimples 9 merge into one another to a certain extent, as can be seen in examples #1 and #3. The difference between the first example #1 and the second example #2 lies solely in the different focus position of the laser. In examples #3 and #4, the differences result from different pulse durations of the laser at a same power. In the examples shown in FIG. 5, the surface was only slightly melted. The heat-affected zone is comparatively small and penetrates the surface only slightly. The examples #6 and #7 in FIG. 5 show a variant at a changed focus position, so that the shape of the laser dimples 9 also changes. The changed focus position results in a deeper heat-affected zone, while the geometric changes on the surface are comparatively small. The individual laser dimples 9 are therefore slightly smaller than, e.g., in examples #4 and #5. Example #8 shows laser dimples 9 arranged completely separate from one another, i.e., laser dimples 9 are arranged at a distance to each other to form a gap, which laser dimples 9 also extend relatively deep into the material. Compared to example #7 in FIG. 5, the power of the laser has been increased.

In the exemplary embodiments, all laser dimples 9 are produced under a protective gas atmosphere. Production without protective gas atmosphere is, however, also possible. Different power levels are used to create different sizes of heat-affected zones. The exemplary embodiments show also that it is not necessarily required to harden the entire surface area. Rather, hardening can also be carried out only partially. The material HDT580F (according to DIN 10338) is used for the micrographs. Another material for the process can be S420MC (according to DIN EN 10149). The required hardness of the ribs is 270 to 340 HV.

The processing direction of the laser and the protective gas are directed from the radial outside to radial inside in order to form a staircase in the rib 4.

The height of the ribs 4 is realized using an embossing tool, and the ribs 4 are toughened (laser hardening) or re-melted and thereby hardened using a laser to produce the laser dimples 9. The direction of the laser and the protective gas are directed from radial outside to radial inside in order to form a staircase in the rib 4.

A motor-vehicle component according to the invention can, advantageously, find application for bolting a front axle carrier to a longitudinal carrier and is generally suitable for any bolted or screwed connection subjected to radial and/or axial stress.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A motor-vehicle component, comprising a metallic component body comprising a mounting opening and a friction structure which surrounds the mounting opening and includes elevations and/or depressions, said friction structure being embossed and hardened, wherein the embossed and hardened friction structure includes laser dimples, and wherein the friction structure includes ribs produced by embossing such as to extend radially outward from the mounting opening.

2. The motor-vehicle component of claim 1, wherein the laser dimples are arranged on the ribs.

3. The motor-vehicle component of claim 1, wherein the ribs have a mean height measured over their length of 0.05 to 0.9 mm.

4. The motor-vehicle component of claim 1, wherein the ribs have a mean height measured over their length of 0.1 to 0.4 mm.

5. The motor-vehicle component of claim 1, wherein the ribs exhibit a staircase structure sloping down to the mounting opening as a result of the laser dimples.

6. The motor-vehicle component of claim 1, wherein the friction structure includes a hardened area with a hardness of 250 HV to 420 HV.

7. The motor-vehicle component of claim 1, wherein the ribs have a height which increases radially outward, wherein a rib crest has a mean pitch of 0.025 to 3°.

8. The motor-vehicle component of claim 1, wherein the ribs have a height which increases radially outward, wherein a rib crest has a mean pitch of 0.5 to 1.5°.

9. The motor-vehicle component of claim 1, wherein the ribs have a height which increases radially outward, wherein a rib crest has an mean pitch of 1° from a radially inner end of the rib crest to a radially outer end of the rib crest.

10. A method for producing a motor-vehicle component, the method comprising:
producing a mounting opening in a metallic component body;
producing a friction structure on a circumference of the mounting opening by an embossing process;
hardening the friction structure by a laser beam process;
forming laser dimples on raised ribs of the friction structure; and
hardening at least one area of the ribs as the laser dimples are formed.
